(19) United States
(12) Patent Application Publication
(10) Pub. No.: US 2012/0311538 A1
(43) Pub. Date: Dec. 6, 2012

(54) Capturing Rich Actionable Feedback on Working Software

(75) Inventors: Siddharth Bhatia, Kirkland, WA (US); Benjamin Amodio, Issaquah, WA (US); Justin Charles Marks, Redmond, WA (US); Sreeguru Ravi Shanker, Hyderabad (IN); Gautam Goenka, Hyderabad (IN)

(73) Assignee: MICROSOFT CORPORATION, Redmond, WA (US)

(21) Appl. No.: 13/153,938

(22) Filed: Jun. 6, 2011

(51) Int. Cl. G06F 9/44

(52) U.S. Cl. 717/126

(57) ABSTRACT

Described is a workflow and procedure that automates the process of requesting feedback on a software solution from a customer (user). A system facilitates creating a feedback request that is sent to a user, by which the user launches the software solution and a feedback tool. Via the tool, the customer provides rich actionable feedback, which is maintained in a data store for subsequent action, e.g., review by a product owner/development team. The development team may take action on the feedback, and notify the user, closing the loop with the user.

### BACKGROUND

A well-known problem among enterprises that build software solutions such as web applications or rich applications is that the software solution that is built often fails to meet the expectations of the customer. For example, a typical scenario is for some customer (e.g., a “stakeholder” using well-known Agile software development terminology, any internal or external application user, a subject matter expert and so forth) to request that a particular software solution be provided. The enterprise's development team puts together the software solution based upon the request, but when it gets sent to the customer, the customer comes to realize that while the product may meet the request as specified, it does not meet the requirements of what the customer actually meant or wanted.

One way to avoid customer dissatisfaction is to review working software with the customer, as various parts are completed, to obtain direct feedback. Today, the procedure to obtain such feedback is to basically carry out a number of manual actions. These include setting up the right software build, inviting the customer for a meeting, taking notes by hand, attempting (after the fact) to reconstruct the path the customer took, and sending the notes and observations to the developers, e.g., via email.

However, this procedure provides the customer and enterprise with a poor experience, and is often unreliable. For example, the feedback sent to the development team may not be actionable, the feedback may be lost or not sent, the feedback may be misinterpreted, and so forth.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards automating the workflow/procedure of requesting and obtaining feedback from a customer (user). A software solution (e.g., application or application piece) is set up to run in an evaluation environment, e.g., a virtual environment such as a virtual machine that runs a rich application, or a hosted web application run on a local machine. A system facilitates creating and sending a request (e.g., via email) for feedback with respect to the software solution, and configures a feedback tool by which feedback is generated by the user. The system receives the feedback on the software solution, and maintains and provides access to the feedback, such as by querying a database in which the feedback is stored, to allow a product owner/development team to take action with respect to the software solution.

In one aspect, the software solution may correspond to one or more pieces of a larger program, each referred to as a user story. The request may specify one or more users and one or more stories (e.g., an Agile user story or a bug/code defect), and may be created based upon interaction with a setup program. For each story, a feedback work item is created and maintained in association with each user in a data store. Feedback state data may be maintained for each work item and associated user. The state data is updated to indicate the state of the feedback request, such as to indicate when the request has been sent to a user prior to feedback being received from that user, when the feedback has been received from that user, when the feedback has been reviewed, or when feedback session has been declined by the user or canceled.

The user may launch the software solution (which may or may not install the software, as needed) via a link and/or using other like information (e.g., file data) provided in the request. The software solution is launched in an evaluation environment or locally on the user's machine, where the software solution is represented as visible information on a display mechanism (e.g., one or more display monitors or the like) for viewing and interacting with the software solution. The feedback tool also may be represented as visible information on the display mechanism, for viewing and interacting with feedback-related content as the user enters such content. The user may use the feedback tool to provide text, zero or more images, arbitrary files, image annotations, and/or recorded audiovisual information, each obtained with respect to the software solution being run in the evaluation environment. The feedback tool may be configured with a mechanism for indicating a bug, and/or a rating mechanism.

A workflow/procedure is described for obtaining feedback, including sending a communication inviting a specified user to return feedback corresponding to evaluating a software solution, and for setting up the software solution to evaluate. A feedback tool is configured to obtain feedback with respect to the evaluation of the software solution by the user, and feedback work items corresponding to received feedback are maintained for subsequent access. The workflow/procedure may create a link corresponding to an action taken on a feedback work item, and each feedback work item may be associated with state indicative of whether for that work item feedback has been requested and not yet received, whether feedback has been received, or whether received feedback has been reviewed. The user may be notified by presenting information to a user that provided the feedback indicative of an action taken based upon the feedback.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example system for requesting and capturing feedback with respect to a software solution.

FIG. 2 is a state diagram representing example states associated with a work item, for tracking feedback state.

FIG. 3 is a representation of an example user interface displayed on a display mechanism corresponding to a feedback tool by which a user may interact with a running software solution and interact with the feedback tool to provide feedback.

FIG. 4 is a representation of an example display showing how feedback may be used to take one or more actions with respect to a software solution.

FIG. 5 is an example workflow diagram showing how feedback may be requested, obtained and used to take action with respect to a software solution.

FIG. 6 shows an illustrative example of a computing environment into which various aspects of the present invention may be incorporated.

### DETAILED DESCRIPTION

Various aspects of the technology described herein are generally directed towards automating the procedure of requesting and obtaining and tracking feedback from a customer with respect to a software solution. In general, via the technology described herein, the customer receives a feedback request to evaluate a software solution, and is provided with a mechanism for providing rich, actionable feedback. Also via the technology described herein, the feedback is maintained, such that a development team is able to take action on the feedback and close the loop with the customer.

It should be understood that any of the examples herein are non-limiting. For one, while software solutions are described herein as being the product that is developed, other products and/or services, as well as post-development, pre-development, reverse engineering, planning and so forth may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and product/service related-operations in general.

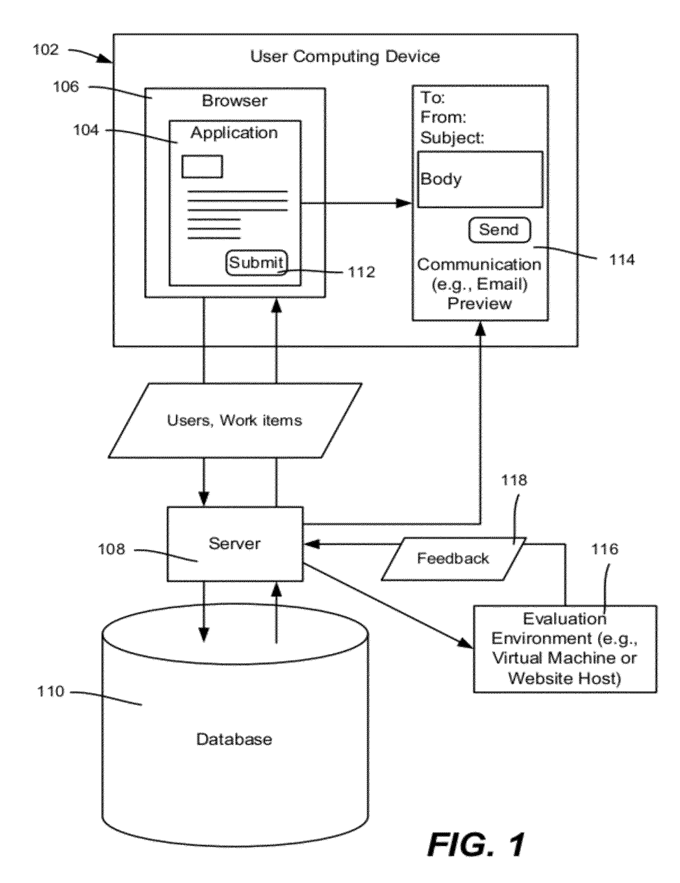

FIG. 1 is a block diagram representing example components of a system configured to provide a mechanism for a product owner or the like (e.g., a development team member) to send requests (invitations) for feedback related to a software solution to a customer (one or more users, such as a stakeholder). The software solution may be a full program, e.g., a particular build, or some functional piece of the program. The system may be used to provide feedback on entities other than software, e.g., a user interface diagram.

In one implementation, at a user computing device 102 such as a personal computer or Smartphone, the product owner runs a web application/webpage 104 or the like on a browser 106 that allows the owner to fill in data on a form related to a request for feedback; (note that the feedback request may be made in any suitable way, e.g., a web application, rich application, an email message, and so forth). Examples of the data that may be filled in include the user or users to whom the request is to be sent, information about the software solution for which feedback is being sought, and optionally a story (or set of stories) that are to be evaluated, where “story” (using Agile terminology) is generally an individual unit of work that provides some value to the software solution. Note that it is feasible to not specify a story, in which event the product owner is requesting general feedback about the specified software solution; a feedback work item may be created on demand for each user when such general feedback is received.

As represented in FIG. 1, a server 108 and suitable data store (e.g., database 110) comprise the back end mechanism (e.g., based upon Microsoft Corporation's Team Foundation Server, or TFS product) that services the product owner computing device's (client) front end actions. For example, in one implementation, each specified story corresponds to a single feedback work item that acts as a placeholder in the database 110, with the specified user or users associated with each such work item as described herein.

When the product owner has specified the appropriate information, the product owner signals completion to the server 108, e.g., by clicking a submit button 112 or the like. In addition to saving the user information and any work item or items in the database 110, the server 108 also generates a communication 114 (e.g., one or more email messages) for the specified users. The email generally indicates how the customer is to proceed, and provides one or more links and/or files to facilitate obtaining the user feedback.

The product owner may preview the communication 114 before sending to the users. Also, the server 108 may perform any validation-related operations at this time, e.g., to ensure that any permissions are valid, that the email server is configured, and so forth, so as to detect any errors as soon as possible.

In one implementation, the product owner and/or server 108, manually and/or automatically, or both, may configure an evaluation environment 116 for running the software solution. As described below, the user runs the software solution in the evaluation environment 116 and provides feedback 118.

For example, for a web application, the evaluation environment 116 may comprise a website that a user may access via a link in their invitation email. Such a website may be provided in a virtual environment rather than in the enterprise's production servers, for example.

Alternatively, for a rich application, the evaluation environment 116 may comprise a virtual machine that the user accesses via a remote desktop connection. This protects the user machine, user privacy, and prevents harm to an actual hosting computer. For such a rich application, the server 108 generates a file (e.g., a Remote Desktop Protocol, or RDP file) with appropriate data, e.g., credentials and other data used to access a remote virtual environment, and attaches the file (or a link thereto) to the communication 114. Note that if there are no stories specified, there are no feedback work items, and thus the communication 114 contains the RDP without accompanying story-related information. The application can also be on a different device, e.g., a Smartphone application, an application on a tablet computing device, and so forth.

Turning to additional details of work item generation, a feedback work item is generated for each piece of feedback. For a story, each feedback work item is associated with m users that receive the invitation to provide feedback, where m is at least one user. If the product owner specifies n work items (stories), the system has m times n pieces of feedback to manage per software solution. In other words, there is one work item of type feedback created in the database for each specified (user, work item) entry. The feedback work item has a two-way link to the user story/bug.

For general feedback, a feedback work item is created on demand when such feedback is received, and linked to the user that provided the feedback. Note that a request for general feedback as well as for story-specific feedback may be forwarded by the user to another person, e.g., an assistant. In the event this occurs and the other person provides feedback, a feedback work item is created on demand when the feedback is received, and linked to the other user that provided the feedback. The original user may also provide feedback. This allows delegation and/or distribution of requests for feedback, although it is feasible to disallow delegation and/or distribution by simply deleting feedback received from unspecified other users.

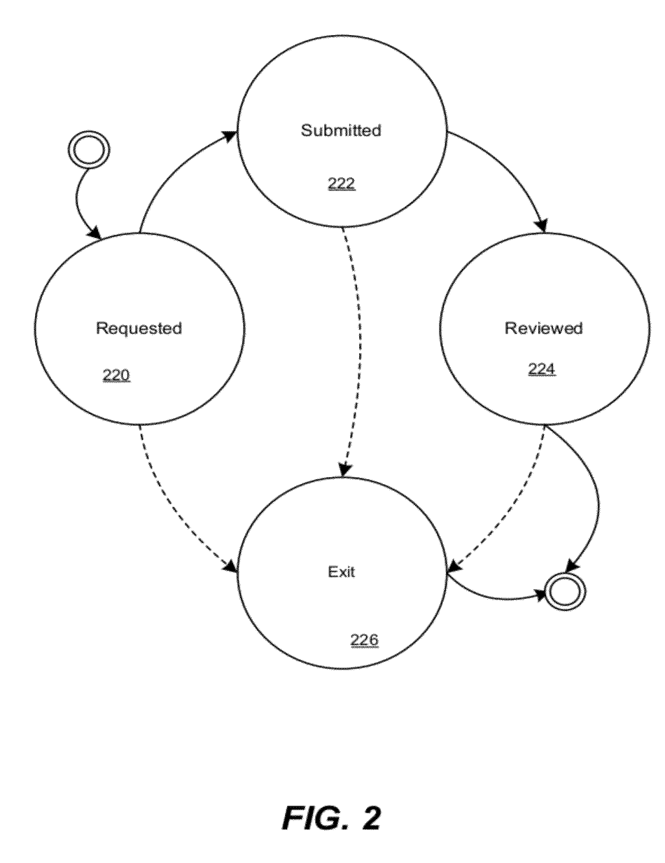

State data is maintained in association with each (user, feedback work item) association, indicating a current state of the feedback in the procedure. As represented in FIG. 2, a feedback work item transitions from a requested state 220 in which the request has been sent. When feedback is returned by a user, the state data for that (user, work item) entry transitions to a submitted state 222. This allows a product owner to query the database for which users still owe feedback, which users have completed providing feedback, and so forth. The requested state 220 also allows users to query for what has been requested of them, e.g., in case a user inadvertently deletes the invitation for feedback.

As described below, when the product owner reviews the feedback, the state data transitions to a reviewed state 224 indicating that the product owner took some action; this state transition may be manually controlled by the product owner. As also represented in FIG. 2, during the procedure, the product owner or user can decline or cancel, corresponding to an exit state 226. Any of this information may be queried, so that the product owner is able to determine what has been completed by the user and the product owner.

Turning to the user experience and a user interface by which the user provides feedback, when the user receives an email and elects to provide feedback, the software solution is launched. For example, if an RDP file is attached to the communication 114, a remote desktop is launched corresponding to a virtual machine, using the credentials provided on the virtual machine. If there is no RDP file, the software solution launches locally, e.g., as a web application hosted in the user's local browser program. Note the application can be launched on a different box/device.

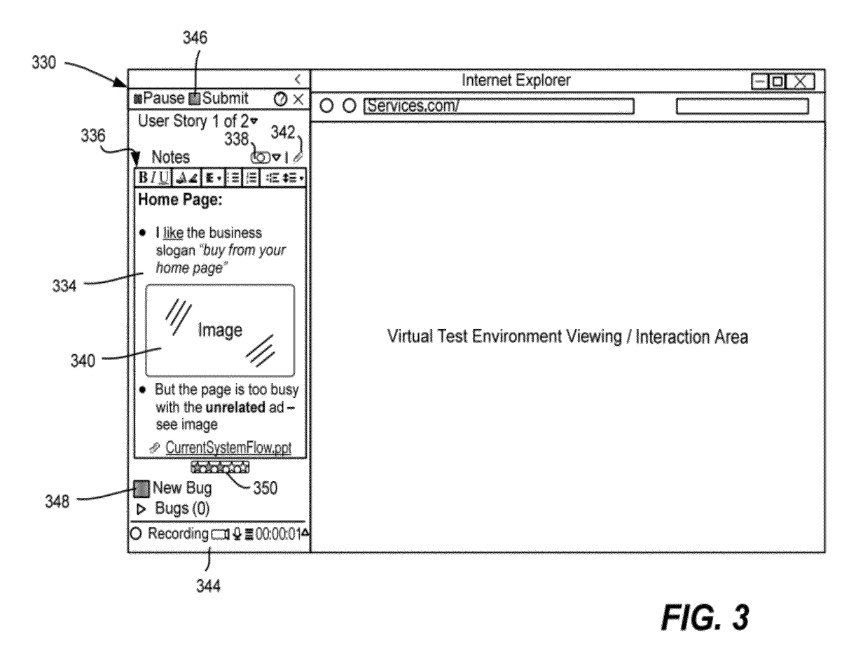

In one implementation generally represented in FIG. 3, a feedback tool (represented by user interface 330) opens automatically, such as on the left side of the user's display mechanism, with the right side providing a virtual environment area 332 for viewing and/or interacting with the software solution being evaluated. Note that the feedback tool can be moved, resized, expanded, collapsed, and so forth. In the example of FIG. 3, a browser is shown hosting a webpage/web application, however it is understood that this may be a rich application such as a word processing application running in a remote desktop/virtual machine environment, for example. It is also feasible to run a rich application directly on a local machine as the evaluation environment.

Via the tool 330, the user may choose a general context or a story context (if a story is specified) for providing feedback, which will be used to link the feedback back to a work item, creating one on demand if necessary as described above. The user may select among available stories if more than one has been specified for the user; each new story selection initially starts with a “clean slate” for user-provided feedback with respect to that story.

In one implementation generally corresponding to FIG. 3, as one part of the feedback, the user is able to input rich text into a work area 334. The user is able to manipulate the text such as for emphasis, e.g., using bold, italic, underline, color, highlighting and so forth, basically in any way desired. The user is able to format the text in other ways, e.g., indent the text, use bullets and numbering, align the text, and so forth. Icons 336 represent this aspect of the tool 330. Another mechanism may provide the user with a smiley/thumbs up icon (or the like), or frown/thumbs down icon (or the like) as an index into the feedback video.

As another type of feedback, the user is also able to use a capture tool (e.g., via icon 338) to insert screenshots and/or screen clips into the work area, depending on what the user desires. Screen capturing technology is known, including by capturing the whole screen or via a snipping tool or the like that allows a mouse or other pointing device to select only a portion of the screen for capture. The user may thus insert one or more images into the work area, such as the image 340. Thumbnail previews, scrolling or other mechanisms may be used for images that are too large for the area 334. An annotation tool (e.g., icon 342) allows for adding one or more captions or the like to the image.

Still further, video of the desktop display as well as audio may be captured during the feedback session, as represented by the recording-related data region 344. Note that this may be previewed and/or edited for privacy before sending to the database. In one implementation the video and audio are merged into one file that is associated with the user and feedback work item as one type of received feedback.

A user may also click a bug button 348 to file a bug and thereby place a work item of type “bug” into the database, such as to emphasize a particularly noteworthy observation. Note that this applies to any work item type; bug is a default example.

A rating tool 350 or the like also may be used for providing feedback. When the user has completed entering and capturing of the feedback, the user presses a submit button 346 or the like, which then sends the feedback to the database, where it is associated with the feedback work item and user identity. In this manner, the user may provide feedback in various ways, including stream of consciousness type feedback, which may be associated with other captured feedback via audio and video. As can be readily appreciated, not every exemplified tool need be used by a user, and indeed not every tool may be provided in alternative implementations. Further, additional tools and/or sensors may be provided to capture feedback in other implementations.

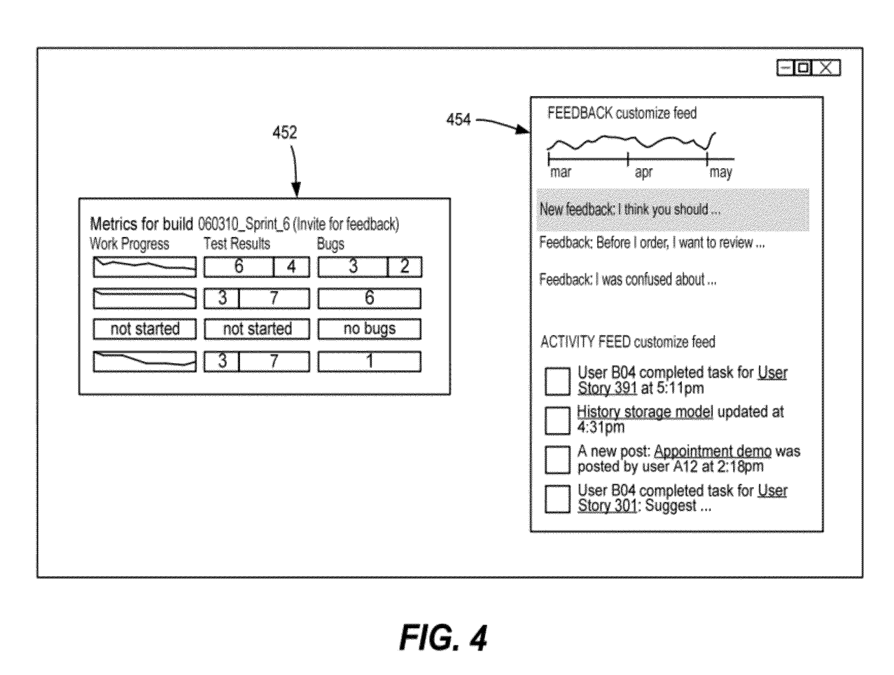

Once the feedback 118 is returned and maintained in the database 110, the product owner is able to use the feedback in various ways, including with other feedback. For example, as generally represented in FIG. 4, various data 452 may be queried, filtered, combined statistically, and so forth. The feedback may be presented in various ways, such as part of a collection 454.

The product owner may search and/or filter feedback by work item ID, text (e.g., keywords) and/or other means (e.g., time, bugs and so forth). The product owner may also evaluate each item of feedback and use it as desired. For example, the product owner is able to read the text, view the images, replay the audiovisual recording, and so forth. The audio and video may be indexed in time and/or by action, so that the owner can quickly jump to the appropriate place in the recording for some event or the like noted in the feedback.

Moreover, the owner may process the feedback in various ways by parsing it and taking action with respect to individual pieces of the feedback. For example, the owner may highlight content and be given a user interface option to add the highlighted content to a new work item (created on demand) or link the highlighted content to an existing other work item. A link to the source work item from which the content was selected to the new or other work item is created. While reviewing the feedback, the product owner can also create a work item of type bug.

Once the review is complete, the owner or an automated process switches switch the state data for the work item to the reviewed state. The developers (e.g., working with the primary product owner) may then query the reviewed feedback, query for bugs, and so on, in order to make appropriate changes to the software solution based upon the feedback. The user may be notified in some way that his or her feedback was used, possibly with comments on the feedback, e.g., what was valuable, ways to improve, and so forth.

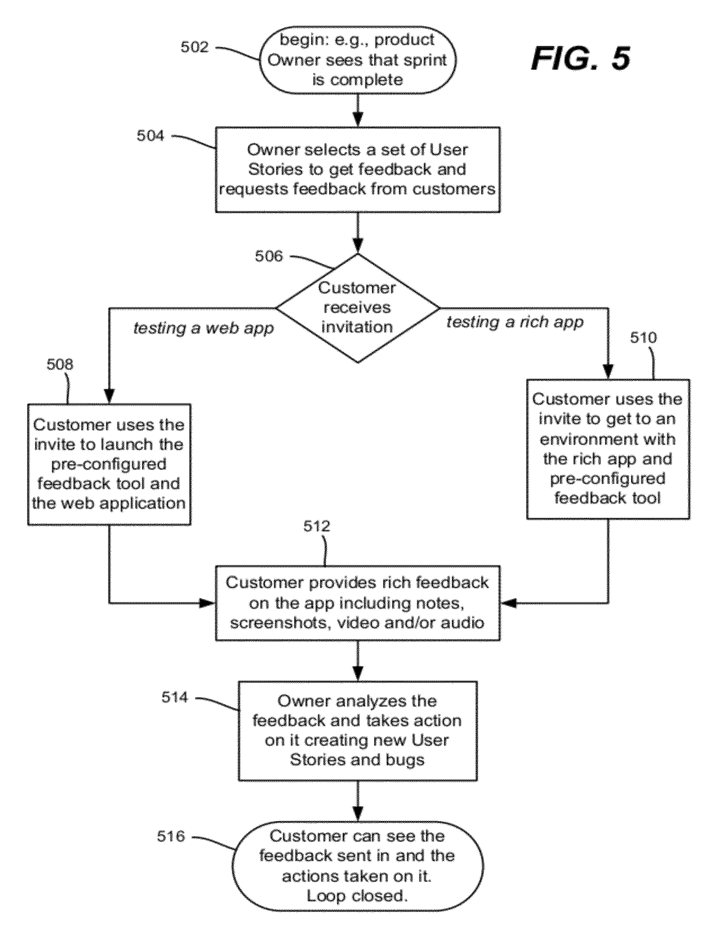

FIG. 5 summarizes a workflow/process via example steps; note that while FIG. 5 shows an example starting when a sprint is complete, these steps may be started at any time. As seen in FIG. 5, the automated process uses successful transitions set up by the system from one step to another. The system creates the feedback invitation, sets up the application to test and configures the feedback tool. The system also creates feedback work items to associate with customer feedback, and creates links based on actions taken on the feedback work items.

In the example of FIG. 5, at step 502 the product owner decides to obtain feedback, e.g., once a sprint (other known terminology representing some timeframe or the like) is complete, such as viewed on the owner's homepage. In one implementation, the system provides such data in the form of a web interface on top of Microsoft Corporation's Team Foundation Server (TFS) product data. At step 504 the owner selects a set of user story work items to get feedback on, and a set of users (customers) to provide the feedback.

The customer receives the invitation as generally described above and as represented in step 506. In the event that the application is a web application, the system creates the feedback request item, generates a feedback invitation for the user, provides a link to the web application to test, provides a link to the feedback tool in the invitation and configures the feedback tool with any previously specified user stories. In the event that the application is a is a rich application, the system creates the feedback request item, generates a feedback invitation for the user, provides a link to the virtual environment, provides a link where the customer can launch the feedback too and configures the feedback tool with any previously specified user stories.

Steps 508 and 510 represent the customer actions based upon providing feedback on a web application or a rich application, respectively. Thus, from the feedback invitation, a web application (step 508), or the virtual machine and application is launched (step 510); also launched is the feedback tool.

Step 312 represents the customer providing rich feedback on the application as described above, e.g., possibly including rich text, screenshots with annotations, audio and video and so forth. Once submitted, the system associates (links) the returned feedback with the corresponding feedback work item or items, and updates the feedback state for this user and work item.

At step 514, the product owner sees the rich feedback arrive, e.g., exposed by the system as feedback items via a web interface on top of TFS, or in some other matter, e.g., a client application. The owner may then take action on the rich feedback, e.g., by creating new bugs, user stories and other work items for the development team to prioritize and take action. The system creates links between the rich feedback, the bugs and the user stories created.

The work item feedback state may be updated to indicate that the customer's feedback has been reviewed, whereby the customer may review the feedback that was created and the actions that were taken, closing the loop. The customer may see the feedback/action-related information, such as via a web interface on top of TFS, for example.

As can be seen, the system provides integration of development and customer evaluation via the workflow automation of requesting feedback, giving feedback and taking action on the feedback, each of which are traceable throughout the feedback-related procedure, thereby providing benefits and advantages over known ways to obtain feedback. The product owner is able to select stories for obtaining feedback, see what has been completed, and trace the feedback throughout the procedure.

### Exemplary Operating Environment

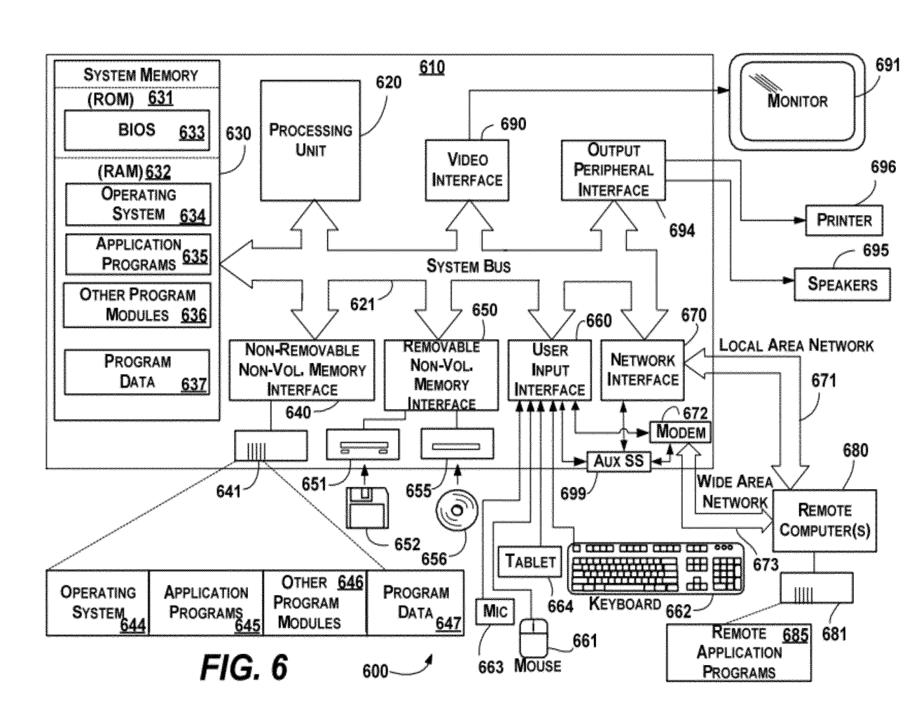

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor, comprising, setting up a software solution to run in an evaluation environment, sending a request for feedback on the software solution, providing a feedback tool, receiving feedback on the software solution, the feedback generated via the feedback tool, and accessing the feedback to take action with respect to the software solution.

2. The method of claim 1 wherein setting up the software solution comprises providing a virtual environment.

3. The method of claim 1 wherein the software solution comprises a web application, and further comprising, launching the web application.

4. The method of claim 1 wherein the software solution comprises a rich application, and further comprising, launching the rich application on a virtual machine, a computer system, a Smartphone or a tablet.

5. The method of claim 1 wherein the software solution corresponds to one or more stories, and further comprising, creating the request including specifying one or more users and one or more stories.

6. The method of claim 5 further comprising, creating a feedback work item for each story, and maintaining each feedback work item in association with each user in a data store.

7. The method of claim 6 further comprising, maintaining feedback state data for each work item and associated user, the feedback state data indicating when the request has been sent to a user prior to feedback being received from that user, when the feedback has been received from that user, or when the feedback has been reviewed.

8. The method of claim 1 wherein sending the request for feedback comprises generating an email message, the email message including a link that when activated launches the software solution.

9. The method of claim 1 wherein accessing the feedback to take action with respect to the software solution comprises querying a database in which the feedback is stored.

10. The method of claim 1 wherein receiving the feedback comprises receiving text, zero or more images, and recorded audiovisual information, each obtained with respect to the software solution being run in the evaluation environment.

11. In a computing environment, a system, comprising, an evaluation environment in which a software solution is run, the software solution being run represented as visible information on a display mechanism for viewing and interacting with the software solution, and a feedback tool configured to obtain feedback with respect to the software solution being run in the evaluation environment, the feedback tool represented as visible information on the display mechanism for viewing and interacting with feedback-related content.

12. The system of claim 11 wherein the feedback tool is configured with a text editor, an image capture mechanism, or a mechanism for annotating an image, or any combination of a text editor, an image capture mechanism, or a mechanism for annotating an image.

13. The system of claim 11 wherein the feedback tool is configured to capture video corresponding to interaction with the software solution, or audio, or both video and audio.

14. The system of claim 13 further comprising a mechanism for viewing or editing, or both viewing and editing, the captured video or audio, or both video and audio.

15. The system of claim 11 wherein the feedback tool is configured with a mechanism for indicating a bug, or a rating mechanism, or both a mechanism for indicating a bug and a rating mechanism.

16. The system of claim 11 further comprising a data store configured to maintain the feedback for subsequent access.

17. One or more computer-readable media having computer-executable instructions, which when executed perform steps, comprising:
sending a communication inviting a specified user to return feedback corresponding to evaluating a software solution;
setting up the software solution to evaluate;
configuring a feedback tool to obtain feedback with respect to the evaluation of the software solution by the user; and
maintaining feedback work items corresponding to received feedback.

18. The one or more computer-readable media of claim 17 having further computer-executable instructions comprising, creating a link corresponding to an action taken on a feedback work item.

19. The one or more computer-readable media of claim 17 having further computer-executable instructions comprising, maintaining state data with each feedback work item indicative of whether for that work item feedback has been requested and not yet received, whether feedback has been received, or whether received feedback has been reviewed.

20. The one or more computer-readable media of claim 17 having further computer-executable instructions comprising, presenting information to a user that provided the feedback indicative of an action taken based upon the feedback.
